(19) United States
(12) Patent Application Publication
(10) Pub. No.: US 2021/0230383 A1
(43) Pub. Date: Jul. 29, 2021

(54) Cast Polyethylene Packaging Films

(71) Applicant: ExxonMobil Chemical Patents Inc., Baytown, TX (US)

(72) Inventors: Giriprasath GURURAJAN, Missouri City, TX (US); Michael A. LEAF, Houston, TX (US); Porter C. SHANNON, Seabrook, TX (US)

(21) Appl. No.: 17/123,529

(22) Filed: Dec. 16, 2020

Related U.S. Application Data
(60) Provisional application No. 62/966,671, filed on Jan. 28, 2020.

(51) Int. Cl. C08J 5/18; C08L 23/06; B32B 27/08; B32B 27/32; B32B 37/14

(52) U.S. Cl. CPC C08J 5/18; C08L 23/06; B32B 27/08; B32B 27/32; B32B 37/14; B32B 2307/72; C08L 2203/16; B32B 2250/02; B32B 2250/242; B32B 2307/546; B32B 2307/30; C08J 2323/06

(57) ABSTRACT

A cast film is made from at least one ethylene polymer which comprises from 75.0 mol % to 100.0 mol % of ethylene derived units and which has a density of from 0.900 g/cm³ to 0.926 g/cm³, a melt index (I_{2.16}) from greater than 1.2 g/10 min to 6 g/10 min, a melt index ratio (I_{21.6}/I_{2.16}) of from 20 to 50, and a z-average molecular weight (M_{z}) of greater 150,000 g/mol. The cast film has an average flex crack resistance as measured by ASTM F392 of less than or equal to 15 holes/300 cm² after 10,000 cycles, preferably 8±1 holes/300 cm² after 10,000 cycles.

### CROSS-REFERENCE TO RELATED APPLICATION

This application claims the benefit of U.S. Provisional Application 62/966,671, filed Jan. 28, 2020, entitled “Cast Polyethylene Packaging Films”, the entirety of which is incorporated by reference herein.

### FIELD

This present disclosure relates to cast polyethylene packaging films.

### BACKGROUND

Polyethylene-containing films, both blown and cast films, are used in a wide variety of packaging applications. For example, edible and non-edible liquids are frequently stored in flexible packaging made from polyethylene-containing films. Liquids are particularly demanding from a packaging standpoint because mishandling, such as dropping the package from an elevated height, can immediately stress the walls of the package leading to rupture of the package. Additionally, the liquid is in constant movement within the package during transportation and handling. This constant motion creates repeated flexing and abrasion of the package which may eventually create pinholes in the film substrate and leakage of the liquid contents. This problem is generally referred to as flex cracking.

Flex cracking is caused by the movement of the liquid within a package, and is most likely to happen where the film is in close proximity to the upper surface of the liquid. Flex cracking can occur during shipping and handling of even the smallest fluid-containing pouches. Flex crack pinholes result in at least loss of oxygen and moisture barrier, reducing the shelf life potential of the product, and often in loss of the hermetic seal, rendering the product unsafe to use if it is a food product. Generally a Flex Crack Resistant Film is one that should develop 15 or less pinholes per 300 cm² in 10,000 cycles of Gelbo Flex testing, preferably 10 or less and more preferably 5 or less, pinholes per 300 cm² in 10,000 cycles. With existing cast polyethylene films, these flex crack numbers can only be achieved by blending the polyethylene resin with low density plastomer resins. However, in view of their cheapness and improved visual clarity, for many applications cast films are preferred to their blown counterparts.

It is well known that film made from a lower density polyethylene will have better flex crack resistance than film made from a higher density polyethylene (see, for example, International Patent Publication No. WO 95/26268). It is also well known that film made from a lower density polyethylene will have inferior thermal resistance and stiffness than film made from a higher density polyethylene (see, for example US Patent Application Publication No. 2005/0131160). However, what is not well understood is how to modify the composition of a polyethylene film to maximize the improvement in flex crack pinhole resistance, while at the same time minimizing the negative effect on thermal resistance and stiffness, which are generally desirable film properties.

Many proposals have been advanced to improve the flex crack resistance of polyethylene films without adversely effecting other mechanical and thermal properties of the film. For example, U.S. Pat. No. 8,252,397 discloses a sealant film for use in a film structure for the manufacture of pouches and bags for containing flowable materials, wherein the sealant film comprises (a) from about 2.0 wt % to about 9.5 wt %, based on 100 wt total composition, of an ethylene C₄-C₁₀-alpha-olefin interpolymer produced using a single-site or metallocene catalyst and having a density of from 0.850 to 0.890 g/cc and a melt index of 0.3 to 5 g/10 min. and (b) from about 70.5 wt % to about 98.0 wt %, based on 100 wt % total composition, of one or more polymers selected from ethylene homopolymers and ethylene C₄-C₁₀-alpha-olefin interpolymers, having a density between 0.915 glee and 0,935 g/cc and a melt index of 0.2 g/10 min to 2 g/1.0 min. While the Examples in the '397 patent show that the blending of the ultra-low density polyethylene improves the flex crack resistance of the base resin, in real world packaging applications this is found to lead to deterioration of the thermal resistance and stiffness of the base resin, compromising the integrity of any package produced from the blend.

More recently, international Patent Publication No. WO 2017/165004 has demonstrated that a certain class of polyethylene resins comprising from 75.0 mol % to 100.0 mol % ethylene derived units and having: a density of from 0.910 g/cm3 to 0.923 g/cm3, a melt index (I_{2.16}) of from 0.1 g/10 min to 1.2 g/10 min, a melt index ratio (I_{21.6/I2.16}) of from 20 to 35, and a weight average molecular weight (Mw) of from 150,000 g/mol to 400,000 g/mol, can be made into a film having a dart drop impact strength (DIS) of ≥40 g/μm and flex crack resistance of ≤5 holes/10,000 cycles, even without blending with ultra-low density plastomer or elastomer resins. However, although these resins exhibit excellent flex crack resistance when converted into blown film, they typically are unsuitable for the production of cast films due to their lower MI range.

Thus there remains interest in developing new polyethylene compositions that can be easily converted into cast films with excellent flex crack resistance and good thermal properties without the need for blending with other plastomers or elastomers.

### SUMMARY

According to one aspect of the present disclosure, there is provided a cast film made from at least one ethylene polymer comprising from 75.0 mol % to 100.0 mol % of ethylene derived units and having:

a density of from 0.900 g/cm³ to 0.926 g/cm³,

a melt index (I_{2.16}) from 1.2 g/10 min to 6 g/10 min,

a melt index ratio (I_{21.6}/I_{2.16}) of from 20 to 50, and

a z-average molecular weight (M_{z}) of greater 150,000 g/mol,

wherein the cast film has an average flex crack resistance as measured by ASTM F392 of less than or equal to 15 holes/300 cm² after 10,000 cycles, preferably 8±1 holes/300 cm² after 10,000 cycles.

In a further aspect, the present disclosure resides in a process for producing a film, the process comprising the steps of: (1) polymerizing ethylene in the presence of a metallocene catalyst system in a gas phase reactor with at least one C₃ to C₁₀ alpha-olefin comonomer to produce a polyethylene composition having a density between about 0.900 g/cm³ and about 0.926 g/cm³, a melt index (I_{2.16}) from 2 g/10 min to 6 g/10 min, a melt index ratio (I_{21.6}/I_{2.16}) of from 20 to 50, and a M_{z} greater than 150,000 g/mol; and (2) casting the polyethylene composition into a film having an average flex crack resistance as measured by ASTM F392 of less than 15 holes/300 cm² after 10,000 cycles, preferably 8±1 holes/300 cm² after 10,000 cycles.

### DETAILED DESCRIPTION

Provided herein is a cast packaging film produced from a polyethylene composition comprising from 75.0 mol % to 100.0 mol % of ethylene derived units and having a density of from 0.900 g/cm³ to 0.926 g/cm³, a melt index (I_{2.16}) from 1.2 g/10 min to 6 g/10 min, a melt index ratio (I_{21.6}/I_{2.16}) of from 20 to 50, and a z-average molecular weight (M_{z}) of greater 150,000 g/mol. The polyethylene composition may be produced by polymerization of ethylene, optionally with one or more C₃ to C₁₀ alpha-olefin comonomers, in the presence of a metallocene catalyst, such as a single site metallocene Hf-P catalyst, in a single or multiple gas phase reactors in series or in parallel. The polyethylene composition may be converted into a film by a cast film process, normally followed by machine direction stretching, to provide a film of improved flex crack resistance.

### Definitions

The term “melt index” or “MI” of a polymer is the number of grams of polymer extruded in 10 minutes under the action of a standard load and is an inverse measure of viscosity. A high MI implies low viscosity and low MI means high viscosity. In addition, polymers are shear thinning, which means that their resistance to flow decreases as the shear rate increases. This is due to molecular alignments in the direction of flow and disentanglements.

As provided herein, MI (I₂, 190° C., 2.16 kg) is determined according to ASTM D-1238-E, also sometimes referred to as I₂ or I_{2.16}.

As provided herein, MI (I₂₁, 190° C., 21.6 kg) is determined according to ASTM D-1238-E, also sometimes referred to as I₂₁ or I_{21.6}.

The term “MIR” is the ratio of I₂₁/I₂ and provides an indication of the amount of shear thinning behavior of the polymer and a parameter that might be correlated to the overall polymer mixture molecular weight distribution (“MWD”) data obtained separately by using Gas Permeation Chromatography (“GPC”) and possibly in combination with another polymer analysis including TREF.

Density values provided herein are as measured in accordance with ASTM D-1505.

As used herein, “Mₙ” is number average molecular weight, “M_{w}” is weight average molecular weight, and “Mₜ” is z-average molecular weight. Unless otherwise noted, all molecular weight units (e.g., M_{w}, Mₙ, M_{z}) including molecular weight data are in the unit of g·mol⁻¹.

As used herein, unless specified otherwise, percent by mole is expressed as “mol %,” and percent by weight is expressed as “wt %.”

MWD is equivalent to the expression M_{w}/Mₙ and is also referred to as polydispersity index (PDI). The expression M_{w}/Mₙ is the ratio of the M_{w} to the Mₙ. The M_{w} is given by

$${M}_{w} = \frac{{\sum }_{i} {n}_{i} {M}_{i}^{2}}{{\sum }_{i} {n}_{i} {M}_{i}}$$

the Mₙ is given by

$${M}_{n} = \frac{{\sum }_{i} {n}_{i} {M}_{i}}{{\sum }_{i} {n}_{i}}$$

and the M_{z} is given by
where nᵢ in the foregoing equations

$${M}_{z} = \frac{{\sum }_{i} {n}_{i} {M}_{i}^{3}}{{\sum }_{i} {n}_{i} {M}_{i}^{2}}$$

is the number fraction of molecules of molecular weight Mᵢ.

Unless otherwise indicated, the distribution and the moments of molecular weight (Mw, Mn, Mz, Mw/Mn, etc.), the comonomer content (C₂, C₃, C₆, etc.) and the branching index (gᵥᵢₛ′) are determined using a high temperature Gel Permeation Chromatograph (Polymer Char GPC-IR) equipped with a multiple-channel band-filter based Infrared detector IR5, an 18-angle light scattering detector and a viscometer. Three Agilent PLgel 10-μm Mixed-B LS columns are used to provide polymer separation. Aldrich reagent grade 1,2,4-trichlorobenzene (TCB) with 300 ppm antioxidant butylated hydroxytoluene (BHT) is used as the mobile phase. The TCB mixture is filtered through a 0.1 μm Teflon filter and degassed with an online degasser before entering the GPC instrument. The nominal flow rate is 1.0 ml/min and the nominal injection volume is 200 μL. The whole system including transfer lines, columns, and detectors are contained in an oven maintained at 145° C. The polymer sample is weighed and sealed in a standard vial with 80 μL flow marker (Heptane) added to it. After loading the vial in the autosampler, polymer is automatically dissolved in the instrument with 8 ml added TCB solvent. The polymer is dissolved at 160° C. with continuous shaking for about 1 hour for most PE samples or 2 hour for PP samples. The TCB densities used in concentration calculation are 1.463 g/ml at room temperature and 1.284 g/ml at 145° C. The sample solution concentration is from 0.2 to 2.0 mg/ml, with lower concentrations being used for higher molecular weight samples. The concentration (c), at each point in the chromatogram is calculated from the baseline-subtracted IR5 broadband signal intensity (I), using the following equation: c=βI, where β is the mass constant. The mass recovery is calculated from the ratio of the integrated area of the concentration chromatography over elution volume and the injection mass which is equal to the predetermined concentration multiplied by injection loop volume. The conventional molecular weight (IR MW) is determined by combining universal calibration relationship with the column calibration which is performed with a series of monodispersed polystyrene (PS) standards ranging from 700 to 10M gm/mole. The MW at each elution volume is calculated with following equation:

$$log M = \frac{log ( {K}_{PS} / K )}{a + 1} + \frac{{a}_{PS} + 1}{a + 1} log {M}_{PS}$$

where the variables with subscript “PS” stand for polystyrene while those without a subscript are for the test samples. In this method, αPS=0.67 and KPS=0.000175 while a and K are for other materials as calculated and published in literature (Sun, T. et al., Macromolecules, 2001, 34, 6812), except that for purposes of the present disclosure, α=0.695 and K=0.000579 for linear ethylene polymers, α=0.705 and K=0.0002288 for linear propylene polymers, α=0.695 and K=0.000181 for linear butene polymers, α is 0.695 and K is 0.000579*(1−0.0087*w2b+0.000018*(w2b)\hat{ }2) for ethylene-butene copolymer where w2b is a bulk weight percent of butene comonomer, ais 0.695 and K is 0.000579*(1−0.0075*w2b) for ethylene-hexene copolymer where w2b is a bulk weight percent of hexene comonomer, and α is 0.695 and K is 0.000579*(1−0.0077*w2b) for ethylene-octene copolymer where w2b is a bulk weight percent of octene comonomer. Concentrations are expressed in g/cm³, molecular weight is expressed in g/mole, and intrinsic viscosity (hence K in the Mark-Houwink equation) is expressed in dL/g unless otherwise noted.

The LS detector is the 18-angle Wyatt Technology High Temperature DAWN HELEOSII. The LS molecular weight (M) at each point in the chromatogram is determined by analyzing the LS output using the Zimm model for static light scattering (Light Scattering from Polymer Solutions; Huglin, M. B., Ed.; Academic Press, 1972):

$$\frac{{K}_{o} c}{Δ R ( θ )} = \frac{1}{MP ( θ )} + 2 {A}_{2} c .$$

Here, ΔR(θ) is the measured excess Rayleigh scattering intensity at scattering angle θ, c is the polymer concentration determined from the IR5 analysis, A₂ is the second virial coefficient, P(θ) is the form factor for a monodisperse random coil, and K_{O} is the optical constant for the system:

$${K}_{o} = \frac{4 {π}^{2} {{n}^{2} ( dn / dc )}^{2}}{{λ}^{4} {N}_{A}} ,$$

where N_{A} is Avogadro's number, and (dn/dc) is the refractive index increment for the system. The refractive index, n=1.500 for TCB at 145° C. and λ=665 nm. For analyzing polyethylene homopolymers, ethylene-hexene copolymers, and ethylene-octene copolymers, dn/dc=0.1048 ml/mg and A₂=0.0015; for analyzing ethylene-butene copolymers, dn/dc=0.1048*(1=0.00126*w2) ml/mg and A₂=0.0015 where w2 is weight percent butene comonomer.

A high temperature Agilent (or Viscotek Corporation) viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, η_{S}, for the solution flowing through the viscometer is calculated from their outputs. The intrinsic viscosity, [η], at each point in the chromatogram is calculated from the equation [η]=η_{S}k, where c is concentration and is determined from the IR5 broadband channel output. The viscosity MW at each point is calculated as

M=K_{PS}M^{α}^{_{PS}}⁺¹/[η],

where αₚₛ is 0.67 and Kₚₛ is 0.000175.

The branching index (g′ᵥᵢₛ) is calculated using the output of the GPC-IR5-LS-VIS method as follows. The average intrinsic viscosity, [η]_{avg}, of the sample is calculated by:

$${[ η ]}_{avg} - \frac{\sum {{c}_{i} [ η ]}_{i}}{\sum {c}_{i}}$$

where the summations are over the chromatographic slices, i, between the integration limits.

The branching index g′ᵥᵢₛ is defined as:

$${g}_{vis}^{′} = \frac{{[ η ]}_{avg}}{{KM}_{v}^{α}}$$

where M_{V} is the viscosity-average molecular weight based on molecular weights determined by LS analysis and the K and α are for the reference linear polymer, which are, for purposes of the present disclosure, α=0.700 and K=0.0003931 for ethylene, propylene, diene monomer copolymers, α=0.695 and K=0.000579 for linear ethylene polymers, α=0.705 and K=0.0002288 for linear propylene polymers, α=0.695 and K=0.000181 for linear butene polymers, α is 0.695 and K is 0.000579*(1−0.0087*w2b+0.000018*(w2b)\hat{ }2) for ethylene-butene copolymer where w2b is a bulk weight percent of butene comonomer, a is 0.695 and K is 0.000579*(1−0.0075*w2b) for ethylene-hexene copolymer where w2b is a bulk weight percent of hexene comonomer, and a is 0.695 and K is 0.000579*(1-0.0077*w2b) for ethylene-octene copolymer where w2b is a bulk weight percent of octene comonomer. Concentrations are expressed in g/cm³, molecular weight is expressed in g/mole, and intrinsic viscosity (hence K in the Mark-Houwink equation) is expressed in dL/g unless otherwise noted. Calculation of the w2b values is as discussed above.

In some embodiments, the high viscosity, long-chain branched polyolefins employed in the present disclosure are prepared by converting solid, high molecular weight, linear, propylene polymer material with irradiating energy as disclosed in U.S. Pat. No. 5,414,027, which is incorporated herein by reference for purpose of U.S. patent practice. Other techniques include treatment of linear polymer with heat and peroxide as disclosed in U.S. Pat. No. 5,047,485, which is incorporated herein by reference for purpose of U.S. patent practice. Other useful high viscosity, long-chain branched polyolefins are disclosed in U.S. Pat. Nos. 4,916,198, 5,047,446, 5,570,595, and European Publication Nos. 0 190 889, 0 384 431, 0 351 866, and 0 634 441, which are also incorporated herein by reference for purpose of U.S. patent practice.

Experimental and analysis details not described above, including how the detectors are calibrated and how to calculate the composition dependence of Mark-Houwink parameters and the second-virial coefficient, are described by T. Sun, P. Brant, R. R. Chance, and W. W. Graessley (Macromolecules, 2001, Vol. 34(19), pp. 6812-6820).

The comonomer composition is determined by the ratio of the IR5 detector intensity corresponding to CH2 and CH3 channel calibrated with a series of PE and PP homo/copolymer standards whose nominal value are predetermined by NMR or FTIR. In particular, this provides the methyls per 1000 total carbons (CH₃/1000TC) as a function of molecular weight. The short-chain branch (SCB) content per 1000TC (SCB/1000TC) is then computed as a function of molecular weight by applying a chain-end correction to the CH₃/1000TC function, assuming each chain to be linear and terminated by a methyl group at each end. The weight % comonomer is then obtained from the following expression in which f is 0.3, 0.4, 0.6, 0.8, and so on for C3, C4, C6, C8, and so on co-monomers, respectively.

w2=f*SCB/1000TC

The bulk composition of the polymer from the GPC-IR and GPC-4D analyses is obtained by considering the entire signals of the CH3 and CH2 channels between the integration limits of the concentration chromatogram. First, the following ratio is obtained.

$$Bulk IR ratio = \frac{Area of {CH}_{3} signal within integration limits}{Area of {CH}_{2} signal within integration limits}$$

Then the same calibration of the CH3 and CH2 signal ratio, as mentioned previously in obtaining the CH3/1000TC as a function of molecular weight, is applied to obtain the bulk CH3/1000TC. A bulk methyl chain ends per 1000TC (bulk CH3end/1000TC) is obtained by weight-averaging the chain-end correction over the molecular-weight range. Then

$$w 2 b - f * bulk CH 3 / 1000 TC$$

$$bulk SCB / 1000 TC = bulk CH 3 / 1000 TC - bulk \frac{CH 3 end}{1000 TC}$$

and bulk SCB/1000TC is converted to bulk w2; in the same manner as described above.

### Polyethylene Composition

The polyethylene compositions employed in the presently described films comprise from about 75.0 mol % to 100.0 mol % of units derived from ethylene. The lower limit on the range of ethylene content can be from 75.0 mol %, 80.0 mol %, 85.0 mol %, 90.0 mol %, 92.0 mol %, 94.0 mol %, 95.0 mol %, 96.0 mol %, 97.0 mol %, 98.0 mol %, or 99.0 mol % based on the mol % of polymer units derived from ethylene. The polyethylene composition can have an upper limit on the range of ethylene content of 80.0 mol %, 85.0 mol %, 90.0 mol %, 92.0 mol %, 94.0 mol %, 95.0 mol %, 96.0 mol %, 97.0 mol %, 98.0 mol %, 99.0 mol %, 99.5 mol %, or 100.0 mol %, based on polymer units derived from ethylene.

In addition to units derived from ethylene, the polyethylene compositions may contain units derived from one or more alpha-olefin comonomer having from 3 to 10 carbon atoms. Alpha-olefin comonomers are selected from monomers having 3 to 10 carbon atoms, such as C₃-C₁₀ alpha-olefins or C₄-C₈ alpha-olefins. Alpha-olefin comonomers can be linear or branched or may include two unsaturated carbon-carbon bonds, i.e., dienes. Examples of suitable comonomers include linear C₃-C₁₀ alpha-olefins and alpha-olefins having one or more C₁-C₃ alkyl branches or an aryl group. Comonomer examples include propylene, 1-butene, 3-methyl-1-butene, 3,3-dimethyl-1-butene, 1-pentene, 1-pentene with one or more methyl, ethyl, or propyl substituents, 1-hexene, 1-hexene with one or more methyl, ethyl, or propyl substituents, 1-heptene, 1-heptene with one or more methyl, ethyl, or propyl substituents, 1-octene, 1-octene with one or more methyl, ethyl, or propyl substituents, 1-nonene, 1-nonene with one or more methyl, ethyl, or propyl substituents, ethyl, methyl, or dimethyl-substituted 1-decene, 1-dodecene, and styrene.

Exemplary combinations of ethylene and comonomers include: ethylene 1-butene, ethylene 1-pentene, ethylene 4-methyl-1-pentene, ethylene 1-hexene, ethylene 1-octene, ethylene decene, ethylene dodecene, ethylene 1-butene 1-hexene, ethylene 1-butene 1-pentene, ethylene 1-butene 4-methyl-1-pentene, ethylene 1-butene 1-octene, ethylene 1-hexene 1-pentene, ethylene 1-hexene 4-methyl-1-pentene, ethylene 1-hexene 1-octene, ethylene 1-hexene decene, ethylene 1-hexene dodecene, ethylene propylene 1-octene, ethylene 1-octene 1-butene, ethylene 1-octene 1-pentene, ethylene 1-octene 4-methyl-1-pentene, ethylene 1-octene 1-hexene, ethylene 1-octene decene, ethylene 1-octene dodecene, and combinations thereof. It should be appreciated that the foregoing list of comonomers and comonomer combinations are merely exemplary and are not intended to be limiting. Often, the comonomer is 1-butene, 1-hexene, or 1-octene.

During copolymerization, monomer feeds are regulated to provide a ratio of ethylene to comonomer, e.g., alpha-olefin, so as to yield a polyethylene having a comonomer content, as a bulk measurement, of from about 0.1 mol % to about 20 mol % comonomer. In other embodiments the comonomer content is from about 0.1 mol % to about 4.0 mol %, or from about 0.1 mol % to about 3.0 mol %, or from about 0.1 mol % to about 2.0 mol %, or from about 0.5 mol % to about 5.0 mol %, or from about 1.0 mol % to about 5.0 mol %. The reaction temperature, monomer residence time, catalyst system component quantities, and molecular weight control agent (such as H2) may be regulated so as to provide desired polyethylene compositions. For linear polyethylenes, the amount of comonomers, comonomer distribution along the polymer backbone, and comonomer branch length will generally delineate the density range.

Comonomer content is based on the total content of all monomers in the polymer. The polyethylene copolymer has minimal long chain branching (i.e., less than 1.0 long-chain branch/1000 carbon atoms, preferably particularly 0.05 to 0.50 long-chain branch/1000 carbon atoms). Such values are characteristic of a linear structure that is consistent with a branching index (as defined below) of g′ᵥᵢₛ≥0.980, 0.985, ≥0.99, ≥0.995, or 1.0. While such values are indicative of little to no long chain branching, some long chain branches can be present (i.e., less than 1.0 long-chain branch/1000 carbon atoms, preferably less than 0.5 long-chain branch/1000 carbon atoms, particularly 0.05 to 0.50 long-chain branch/1000 carbon atoms).

The polyethylene compositions employed herein have a density of from 0.900 g/cm³ to 0.926 g/cm³. The lower limit on the density range can be from 0.900 g/cm³, such as from 0.905 g/cm³, such as from 0.910 g/cm³, such as from 0.912 g/cm³, while the upper limit can be up to 0.915 g/cm³, such as up to 0.920 g/cm³, such as up to 0.922 g/cm³, such as up to 0.924 g/cm³, such as up to 0.926 g/cm³.

The subject polyethylene compositions have an MI (I₂, 190° C., 2.16 kg) as measured by ASTM D-1238-E of 1.2 to about 6 g/10 min. The lower limit on the MI range can be from about 1.2 g/10 min, such as from about 2.3 g/10 min, such from about 2.5 g/10 min, such as from about 3.0 g/10 min, while the upper limit can up to about 3.5 g/10 min, such as up to about 4.0 g/10 min, such as up to about 4.5 g/10 min, such as to about 5.0 g/10 min, such as up to about 5.5 g/10 min, such as up to about 6 g/10 min.

The subject polyethylene compositions have a melt index ratio (I₂₁₆/I₂₁₆) of from 20 to 50. The lower limit on the melt index ratio range can be from about 20, such as from about 25, such as from about 27, whereas the upper limit can range up to 30, such as up to about 35, such as up to about 40, such as up to about 45, such as up to about 50.

The subject polyethylene compositions have a z-average molecular weight (M_{z}) of greater 150,000 g/mol, such as at least 175,000 g/mol, such as at least 200,000 g/mol. Generally, the upper limit on the z-average molecular weight (M_{z}) of the polyethylene compositions employed herein is 400,000 g/mol, more preferably 300,000 g/mol.

The subject polyethylene compositions generally have a molecular weight distribution, M_{w}/Mₙ, of at least 3, such as at least 3.5, preferably from 3.5 to 5.

The polyethylene compositions can have a broad orthogonal comonomer distribution. The term “broad orthogonal comonomer distribution” is used herein to mean across the molecular weight range of the ethylene polymer, comonomer contents for the various polymer fractions are not substantially uniform and a higher molecular weight fraction thereof generally has a higher comonomer content than that of a lower molecular weight fraction. Both a substantially uniform and an orthogonal comonomer distribution may be determined using fractionation techniques such as gel permeation chromatography-differential viscometry (GPC-DV), temperature rising elution fraction-differential viscometry (TREF-DV) or cross-fractionation techniques.

The present polyethylene compositions typically have a broad composition distribution as measured by CDBI or solubility distribution breadth index (“SDBI”). For details of determining the CDBI or SDBI of a copolymer, see, for example, PCT Publication No. WO 93/03093, published Feb. 18, 1993. Polymers produced using a catalyst system described herein have a CDBI less than 50%, or less than 40%, or less than 30%. In an aspect, the polymers have a CDBI of from 20% to less than 50%. In an aspect, the polymers have a CDBI of from 20% to 35%. In an aspect, the polymers have a CDBI of from 25% to 28%.

Polyethylene compositions described herein have a SDBI greater than 15° C., or greater than 16° C., or greater than 17° C., or greater than 18° C., or greater than 20° C. In an aspect, the polymers have a SDBI of from 18° C. to 22° C. In an aspect, the polymers have a SDBI of from 18.7° C. to 21.4° C. In an aspect, the polymers have a SDBI of from 20° C. to 22° C.

In an aspect, the present polyethylene compositions comprise ethylene-based polymers which include LLDPE produced by gas-phase polymerization of ethylene and, optionally, an alpha-olefin with a catalyst having as a transition metal component a bis(n-C_{3-4 alkyl cyclopentadienyl) hafnium compound, wherein the transition metal component comprises from about} 95 to about 99 mol % of the hafnium compound.

Generally, polyethylene can be polymerized in any catalytic polymerization process, including solution phase processes, gas phase processes, slurry phase processes, and combinations of such processes known to those skilled in the art. An exemplary process used to polymerize ethylene-based polymers, such as LLDPEs, is as described in U.S. Pat. Nos. 6,936,675 and 6,528,597, which are each incorporated herein by reference. To produce the present polyethylene compositions, however, a single site metallocene catalyst Hf-P catalyst in a single gas phase process is preferred.

The above-described processes can be tailored to achieve desired polyethylene compositions. For example, comonomer to ethylene concentration or flow rate ratios are commonly used to control composition density. Similarly, hydrogen to ethylene concentrations or flow rate ratios are commonly used to control composition molecular weight.

### Films

Exemplary films are prepared by any conventional technique known to those skilled in the art to prepare extruded, and/or cast stretch and/or shrink films (including shrink-on-shrink applications).

End uses of the cast films described herein include, for example, stretch films, stretch/cast films, stretch cling films, stretch handwrap films, machine stretch wrap, shrink films, shrink wrap films, green house films, laminates, and laminate films.

In particular, the films may be used to fabricate structures for flowable materials and liquid packaging, such as pouches made from multilayer films where stiffness and toughness, flex crack resistance, and sealability and machinability become paramount properties to the end use application. Exemplary applications include but are not limited to bag-in-box packaging, non-laminated pillow packs, flexible food packaging, laminates, laminated constructions such as stand-up pouches and pillow packs, thicker films for large containers, etc. Some of these examples have been described in, for example, U.S. Pat. No. 5,972,443.

As used herein, the term “flowable material” refers to materials that are flowable under gravity or may be pumped or moved by some other mechanical means. Such materials include liquids, e.g., milk, water, soda, flavored waters, fruit juice, wine, beer, spirits, oil; emulsions, e.g., ice cream mix, soft margarine; pastes, e.g., meat pastes, peanut butter; preserves, e.g., jams, pie fillings, marmalade; jellies; doughs; ground meat e.g., sausage meat; powders e.g., gelatin powders, detergents; granular solids e.g., nuts, sugar; and like materials.

In a class of embodiments, multilayer films or multiple-layer films may be formed by methods well known in the art such as coextrusion. For example, the materials forming each layer may be coextruded through a coextrusion feedblock and die assembly to yield a film with two or more layers adhered together but differing in composition, provided at least one layer is produced from the polyethylene composition described herein. Coextrusion can be adapted for use in both cast film or blown film processes. Suitable multilayer films comprise at least one skin layer, a core layer, and optionally, one or more intermediary layers, with at least one of the skin layer, the core layer, or optional intermediary layer comprising from 30 wt % to 100 wt % of the polyethylene polymer described above, based upon the total weight of the skin layer, the core layer, or optional intermediary layer.

The films may be tailored to specific applications by adjusting the thickness, materials and order of the various layers, as well as the additives and other components in each layer. The total thickness of a monolayer or multilayer films may vary based upon the application desired. Generally, the film thickness is at least 0.5 mil, preferably at least 1 mil and is less than 60 mil, preferably less than 50 mil. A total film thickness of from about 1.0 mil to about 5.0 mil is suitable for many applications. Alternative embodiments include from about 1.5 mil to about 4.0 mil, from about 2.0 mil to about 4.0 mil, from about 2.5 mil to about 4.0 mil, or from about 3.0 mil to about 4.0 mil. In another class of embodiments, the film may have a film thickness of >1 mil, a film thickness of >3 mil, or a film thickness of >5 mil. Those skilled in the art will appreciate that the thickness of individual layers may be adjusted based on the desired end use application and performance, resin(s) employed, equipment capability, desired output and operability constraints, and other factors.

After formation, the film may be subjected to post processing such as machine direction orientation, biaxial stretching or lamination or combination of both.

In any of the embodiments described herein, the film may be measured for flex crack resistance. Flex crack resistance may be measured using the Gelbo flex test method. This test method is useful for simulating the flexing and bending conditions imposed on, for example, flexible packaging films. This simulation gives an indication about the real-life treatment of packed products during transport and/or storage.

The Gelbo flex test method described herein is based on ASTM F392 and utilizes a Gelbo Flex Tester, model 5000, available from United States Testing Company, Inc. The Gelbo Flex Tester consists of a 3.5 inch diameter stationary head, and a 3.5 inch diameter movable head, spaced at a distance of 7 inch, face to face. The shoulders (0.5 inch wide) on each head, are used to fix the test specimen. The motion of the movable head is controlled by a grooved, reciprocating shaft. The stroke of the shaft is adjustable from 6 inch to 3.5 inch, to accommodate the testing of the materials. The flexing speed is 40 cycles per minute and a full cycle consists of one forward stroke and one return stroke. The grooved shaft is so designed that by requiring the 6 inch movement stroke, one obtains a twisting motion of 440° during the first 3.5 inch travel, followed by a straight horizontal 2.5 inch travel.

The Gelbo flex test method is performed at about 21° C. The test begins with cutting a film sample at the following dimensions: length=22 cm (film transverse direction) and width=30 cm (film machine direction). The film used to produce the sample should have a thickness of 15 to 25 μm, normally 20 μm. The handwheel on the motor shaft is turned to bring the circular heads to their maximum opened positions. The film sample is installed and the clamps are closed. The sliding door is closed and the counter is then set to 10,000 cycles. The test is initiated until completion of the cycles. Once completed, the test sample is formed into a bag. The bag is placed in a vacuum chamber filled with water, and the pressure in the chamber is decreased down to a pressure of 213 mbar (atmospheric pressure—800 mbar) that cause the bag to inflate. Air escapes from the holes, which are then counted. The number of holes in the sample is the value of the film's flex crack resistance. The lower the number of holes, the better the flex crack resistance.

In some embodiments, the films described herein may have an average flex crack resistance less than or equal to 15 holes/300 cm² after 10,000 cycles, and preferably less than or equal to 9 holes/300 cm² after 10,000 cycles, such as 8±1 holes/300 cm² after 10,000 cycles. These values are obtained on cast films consisting essentially of the polyethylene composition described herein, that is without the addition of plastomer resin, and are each based on the average of 4 or more separate Gelbo flex tests on the film sample.

In any of the embodiments described herein, the film may be measured for Dart Drop Impact or Dart Drop Impact Strength (DIS), reported in grams (g), (g/mil), or (g/μm) and measured as in accordance with ASTM D-1709, method A. The dart head is phenolic. It calculates the impact failure weight, i.e., the weight for which 50% of the test specimens will fail under the impact.

In some embodiments, the films described herein may have a dart drop impact strength (DIS) of ≥100 g/mil, a dart drop impact strength (DIS) of ≥500 g/mil, a dart drop impact strength (DIS) of ≥1,000 g/mil, a dart drop impact strength (DIS) of ≥1,500 g/mil, a dart drop impact strength (DIS) of ≥2,000 g/mil, or a dart drop impact strength (DIS) of ≥2,250 g/mil.

Alternatively, the films may have a dart drop impact strength (DIS) of ≥30 g/μm, a dart drop impact strength (DIS) of ≥40 g/μm, a dart drop impact strength (DIS) of ≥50 g/μm, a dart drop impact strength (DIS) of >60 g/μm, a dart drop impact strength (DIS) of ≥80 g/μm, or a dart drop impact strength (DIS) of ≥100 g/μm.

The present disclosure will now be more particularly described with reference to the following non-limiting Examples and the accompanying drawings.

### Test Methods

The properties cited below were determined in accordance with the following test procedures. Where any of these properties is referenced in the appended claims, it is to be measured in accordance with the specified test procedure.

Where applicable, the properties and descriptions below are intended to encompass measurements in both the machine and transverse directions. Such measurements are reported separately, with the designation“MD” indicating a measurement in the machine direction, and “TD” indicating a measurement in the transverse direction.

Film thickness, reported in microns, was measured using a Measuretech Series 200 instrument. The instrument measures film thickness using a capacitance gauge. For each film sample, ten film thickness data points were measured per inch of film as the film was passed through the gauge in a transverse direction. From these measurements, an average gauge measurement was determined and reported.

1% Secant Modulus (M), reported in megapascal (MPa), was measured as specified by ASTM D-882. The average modulus (AVG modulus) is the arithmetic average of 1% secant moduli measured in machine direction (MD) and transverse direction (TD).

Dart F50, or Dart Drop Impact or Dart Drop Impact Strength (DIS) was measured as specified by ASTM D-1709, method A, as stated above.

The tear testing of films in the machine and transverse directions was conducted on a ProTear Elmendorf Tearing Tester using the ASTM D 1922-15 method. 10 specimens were tested and an average value in grams is reported from these measurements.

Haze was measured with HazeGard PLUS Hazemeter using method ASTM D1003. Haze is the percentage of transmitted light passing through the film that is deflected more than 2.5°. At least 3 film specimens are tested and average value (%) is reported from these measurements.

The yield strength of the films in MD and TD was measured using an internally developed test based on the procedure of ASTM D 882. The yield point is the first stress in a material, less than the maximum attainable stress at which an increase in a strain occurs without an increase in stress. The yield strength is reported as the tensile stress at yield with a 2% offset in which a line parallel to the initial straight-line portion of the stress-strain curve will meet at the 2% strain in the strain axis.

### Example 1: Production of Polyethylene Resins

Eighteen different polyethylene compositions based on a metallocene hafnium (Hf-P) catalyst system were produced in a single gas phase reactor as described in U.S. Pat. Nos. 6,936,675B2 and 6,528,597B2. The resultant polyethylene compositions ranged in density from 0.9127 g/cm³ to 0.9261 g/cm³, in MI (I₂, 190° C. 2.16 kg) from 2.3 g/10 min to 5.23 g/10 min, in MIR from 26.4 to 39.0 and in M_{z} from 174515 to 238629. The characteristics of the polyethylene compositions (designated PE1 to PE18) are summarized in Table 1 together with those of the commercially available polyethylene resins Exceed™ 2018 HA, Exceed™ 3518 CB and Exceed™ XP 8656 ML supplied by ExxonMobil Chemical.

TABLE 1

| | l₂ g/l0 | MIR | Density | Mn | Mw | Mz | | C6 |
|---|---|---|---|---|---|---|---|---|
| Sample | min | I21/I2 | g/cc | (g/mol) | (g/mol) | (g/mol) | Mw/Mn | (wt %) |
| Exceed ™ | 3.6 | 16.4 | 0.9195 | 28692 | 74472 | 134068 | 2.6 | 7.53 |
| 3518CB | | | | | | | | |
| Exceed ™ | 1.89 | 15.85 | 0.9185 | 35150 | 96132 | 173180 | 2.73 | 7.25 |
| 2018HA | | | | | | | | |
| Exceed ™ XP | 0.5 | 30 | 0.916 | 34824 | 132267 | 319463 | 3.80 | 9.46 |
| 8656 ML | | | | | | | | |
| PE1 | 3.6 | 28.5 | 0.9197 | 22055 | 78281 | 193256 | 3.6 | 9.55 |
| PE2 | 3.7 | 27.9 | 0.9127 | 22546 | 78532 | 187663 | 3.5 | 11.62 |
| PE3 | 2.3 | 29.1 | 0.9205 | 26270 | 96904 | 236988 | 3.7 | 8.7 |
| PE4 | 5.02 | 26.4 | 0.9194 | 21283 | 75186 | 174515 | 3.5 | 9.5 |
| PE5 | 3.02 | 39.0 | 0.9216 | 19994 | 83381 | 238629 | 4.17 | 9 |
| PE6 | 2.95 | 27.3 | 0.9203 | 22554 | 82830 | 207006 | 3.67 | 8.63 |
| PE7 | 2.93 | 28.0 | 0.9200 | 22902 | 83032 | 207394 | 3.63 | 8.50 |
| PE8 | 3.13 | 27.8 | 0.9212 | 22519 | 81366 | 205087 | 3.61 | 8.45 |
| PE9 | 3.2 | 31.5 | 0.9207 | 21449 | 81202 | 214189 | 3.79 | 8.8 |
| PE10 | 4.44 | 33.9 | 0.9202 | 19069 | 74759 | 199755 | 3.92 | 9.50 |
| PE11 | 4.36 | 34.1 | 0.9202 | 19330 | 75321 | 200503 | 3.90 | 9.42 |
| PE12 | 3.49 | 32.9 | 0.9258 | 21867 | 81181 | 233436 | 3.71 | 6.95 |
| PE13 | 2.79 | 29.2 | 0.9261 | 23973 | 84916 | 233637 | 3.54 | 6.40 |
| PE14 | 5.23 | 31.4 | 0.9256 | 19210 | 71678 | 195433 | 3.73 | 7.29 |
| PE15 | 5.18 | 36.5 | 0.9252 | 18152 | 72276 | 208569 | 3.98 | 8.04 |
| PE16 | 5.23 | 35.4 | 0.9247 | 18294 | 72882 | 211713 | 3.98 | 8.06 |
| PE17 | 5.2 | 35.4 | 0.9250 | 18300 | 72211 | 208039 | 3.95 | 8.06 |
| PE18 | 4.77 | 33.5 | 0.9255 | 19435 | 74432 | 213145 | 3.83 | 7.57 |

It can be seen from Table 1 that the inventive PE resins generally have a broader molecular weight distribution (Mw/Mn>3) and a higher MIR (greater than 20) with z-average molecular weight greater than 173,000 g/mol as compared to the commercial Exceed 3518 and 2018 resin compositions. At 0.920d, the inventive PE resins (PE1, PE3, PE4, PE6, PE7, PE9, PE10, PE11) have higher C6 comonomer content (>8 wt %) compared to Exceed resins at the same density. The comonomer content also increases with MIR as noted in PE 5 with a MIR of 39 MIR compared to other resins (PE 6, PE 7, PE8) that have a MIR of ˜28 MIR.

The polymerization conditions used to produce the polyethylene compositions designated PE1 to PE18 are summarized in U.S. Patent Application Ser. No. 62/691,444 filed Jun. 28, 2018.

### Example 2: Production and Testing of Cast Films

The resins PE1 to PE4 and a commercial Exceed™ 3518 CB resin were made into monolayer cast films using a Black Clawson cast extrusion line. Table 2 provides the cast film extrusion processing conditions used to make the films. As noted, relative to Exceed 3518CB, PE1 (same density and MI) offers better processability, as noted from extruder head pressure and motor load, due to the broad molecular weight distribution of the PE1 resin.

TABLE 2

| | Resin | | | | |
|---|---|---|---|---|---|
| | Exceed ™ | | | | |
| Processing | 3518CB | PE1 | PE2 | PE3 | PE4 |
| Die Temp (F.) | 550 | 550 | 550 | 550 | 550 |
| Chill Roll Temp (F.) | 80 | 80 | 80 | 83 | 82 |
| Upstream Temp Ext A (F.) | 548 | 542.9 | 541.9 | 563 | 554 |
| Upstream Temp Ext B (F.) | 540 | 541 | 540 | 540 | 536 |
| Downstream Temp Ext A (F.) | 552.1 | 549.9 | 549.9 | 555 | 549 |
| Downstream Temp Ext B (F.) | 498 | 495 | 494.1 | 500 | 484 |
| Head Pressure Ext A (psi) | 1968.3 | 1660.6 | 1726.5 | 2466 | 1614 |
| Head Pressure Ext B (psi) | 1973.1 | 1665.4 | 1685 | 2462 | 1675 |
| Screen Pressure Ext A (psi) | 1514 | 1296.7 | 1335.8 | 1934 | 1297 |
| Screen Pressure Ext B (psi) | 1011 | 832.7 | 844.9 | 1495 | 1009 |
| Motor Load Ext A (A) | 114.5 | 88.9 | 96.9 | 125 | 93 |
| Motor Load Ext B (A) | 131 | 101.5 | 108.3 | 132 | 107 |
| A/B Avg. Processing | 6.93 | 5.54 | 5.51 | 7.54 | 5.01 |
| Resistance (psi-hr/lb) | | | | | |
| Die gap (mil) | 20 | 20 | 20 | 20 | 20 |
| Die width (in) | 42 | 42 | 42 | 42 | 42 |
| Lay Flat (in) | 33.5 | 32.5 | 32 | 34 | 34.5 |
| Die-Roll Distance (in) | 5.75 | 5.75 | 5.75 | 5.75 | 5.75 |
| Rate (lb/hr) | 474.6 | 501.3 | 517.5 | 563 | 565.9 |
| Line Speed (fpm) | 750 | 900 | 750 | 771 | 771 |
| Neck-in Ratio | 0.798 | 0.774 | 0.762 | 0.810 | 0.821 |
| Draw Ratio | 26.7 | 31.3 | 24.7 | 25.3 | 28.6 |

Table 3 provides the mechanical properties of the cast films. At the same density and MI, the mechanical properties of the cast film made from PE1 are similar to Exceed 3518, however PE1 has slightly higher melt temperature at −120° C. The resin PE 2 (913d, 3.7 MI) films show a good combination of dart and tear, while the PE 3 resin based film not only offers excellent flex-crack resistance (8 pinholes in 300 cm2/10000 cycles) similar to a blown film made using Exceed™ XP 8656ML polyethylene, but also exhibits excellent balance of stiffness, toughness and tear.

TABLE 3

| | Resin | | | | |
|---|---|---|---|---|---|
| | Exceed ™ | | | | |
| | 3518CB | PE1 | PE2 | PE3 | PE4 |
| Resin Testing | | | | | |
| MI | 3.57 | 3.61 | 3.7 | 2.26 | 5.02 |
| HLMI | 58.6 | 102.8 | 103.2 | 65.8 | 132.7 |
| MIR | 16.4 | 28.5 | 27.9 | 29.1 | 26.4 |
| Pellet Density (g/cc) | 0.9195 | 0.9197 | 0.9127 | 0.9205 | 0.9194 |
| Gauge (mil) | | | | | |
| Mean | 0.75 | 0.64 | 0.81 | 0.79 | 0.7 |
| 1% Secant (psi) | | | | | |
| MD | 16670 | 17232 | 12854 | 19,800 | 18,099 |
| TD | 18497 | 18675 | 14327 | 21,385 | 20,028 |
| Yield Strength (psi) | | | | | |
| MD | 1129 | 1131 | 968 | 1,135 | 997 |
| TD | 1014 | 1064 | 955 | 1,043 | 943 |
| Dart (A Phenolic) | | | | | |
| Dart Drop (g/mil) | 206.7 | 183.6 | 869.1 | 359 | 174 |
| Haze (%) | 2.55 | 2.06 | 1.34 | 2.4 | 2.9 |
| Elmendorf Tear | | | | | |
| MD (g/mil) | 227 | 233 | 322 | 285 | 331 |
| TD (g/mil) | 591 | 593 | 510 | 562 | 691 |
| DSC (Tm), ° C. | 114, 108 | 121 | 119, 109 | | |

### Example 3: Flex Crack Resistance Testing

Table 4 shows the flex crack resistance data from Gelbo flex test (ASTM F392 based) for films made from commercially produced resins such as Exceed™ 3518, Exceed™ XP 8656ML polyethylenes and also inventive resins (PE1, PE2, and PE3). It can be noted that the inventive resins (2.3 MI-3.6 MI) show significantly lower pinholes/10000 cycles compared to Exceed 3518 and equivalent to commercial Exceed™ XP 8656ML polyethylene blown films indicating that the unique molecular composition of these inventive resins makes them resistant to a high number of flexing cycles. The composition PE3 at 2.3 MI provides good melt strength and is suitable for cast and blown film applications.

TABLE 4

| | | 10 000 | | | | |
|---|---|---|---|---|---|---|
| | | cycles | 10 000 | 10 000 | 10 000 | 10 000 cycles |
| | | Cast Film | cycles | cycles | cycles | Blown Film |
| | | Exceed ™ | Cast Film | Cast Film | Cast Film | Exceed ™ XP |
| | | 3518 CB | PE1 | PE2 | PE3 | 8656ML |
| | | 18.75 μm | 16 μm | 20 μm | 20 μm | 25 μm |
| # Holes | Test 1 | 20 | 12 | 16 | 7 | 4 |
| # Holes | Test 2 | 25 | 14 | 12 | 10 | 4 |
| # Holes | Test 3 | 25 | 10 | 14 | 8 | 8 |
| # Holes | Test 4 | 23 | 15 | 14 | 8 | 2 |
| # Holes | Average | 23 | 13 | 14 | 8 | 5 |
| | STDV | 2 | 2 | 2 | 1 | 3 |

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All priority documents are herein fully incorporated by reference for all jurisdictions in which such incorporation is permitted and to the extent such disclosure is consistent with the description of the present invention. Further, all documents and references cited herein, including testing procedures, publications, patents, journal articles, etc. are herein fully incorporated by reference for all jurisdictions in which such incorporation is permitted and to the extent such disclosure is consistent with the description of the present invention.

While the invention has been described with respect to a number of embodiments and examples, those skilled in the art, having benefit of this disclosure, will appreciate that other embodiments can be devised which do not depart from the scope and spirit of the invention as disclosed herein.

1. A cast film made from at least one ethylene polymer comprising from 75.0 mol % to 100.0 mol % of ethylene derived units and having:
a density of from 0.900 g/cm³ to 0.926 g/cm³,
a melt index (I_{2.16}) from 1.2 g/10 min to 6 g/10 min,
a melt index ratio (I_{21.6}/I_{2.16}) of from 20 to 50, and
a z-average molecular weight (M_{z}) of greater 150,000 g/mol.
wherein the cast film has an average flex crack resistance as measured by ASTM F392 of less than 15 holes/300 cm² after 10,000 cycles.

2. The cast film of claim 1, further having an average flex crack resistance as measured by ASTM F392 of 8±1 holes/300 cm² after 10,000 cycles.

3. The cast film of claim 1, further having a thickness less than or equal to 60 mil.

4. The cast film of claim 1, having a thickness of at least 1 mil.

5. The cast film of claim 1, wherein the at least one ethylene polymer has a melt index (I_{2.16}) from 2 g/10 min to 4 g/10 min.

6. The cast film of claim 1, wherein the at least one ethylene polymer has a melt index ratio (I_{21.6}/I_{2.16}) of from 25 to 40.

7. The cast film of claim 1, wherein the at least one ethylene polymer has a density of from 0.910 g/cm³ to 0.926 g/cm³.

8. The cast film of claim 1, wherein the at least one ethylene polymer has a molecular weight distribution (Mw/Mn) greater than 3.

9. The cast film of claim 1, having a dart drop impact strength of at least 100 g/μm as measured in accordance with ASTM D1709.

10. The cast film of claim 1, wherein the cast film is produced by a process comprising:
(1) polymerizing ethylene in the presence of a metallocene catalyst system in a gas phase reactor with at least one C₃ to C₁₀ alpha-olefin comonomer to produce the ethylene polymer; and
(2) casting the ethylene polymer into a film having an average flex crack resistance as measured by ASTM F392 of less than 15 holes/300 cm² after 10,000 cycles.

11. A process for producing a film, the process comprising:
(1) polymerizing ethylene in the presence of a metallocene catalyst system in a gas phase reactor with at least one C₃ to C₁₀ alpha-olefin comonomer to produce a polyethylene composition having a density between about 0.900 g/cm³ and about 0.926 g/cm³, a melt index (I_{2.16}) from 2 g/10 min to 6 g/10 min, a melt index ratio (I_{21.6}/I_{2.16}) of from 20 to 50, and a M_{z} greater than 150,000 g/mol; and
(2) casting the polyethylene composition into a film having an average flex crack resistance as measured by ASTM F392 of less than 15 holes/300 cm² after 10,000 cycles.

12. The process of claim 11, wherein the cast film has an average flex crack resistance as measured by ASTM F392 of 8±1 holes/300 cm² after 10,000 cycles

13. A film laminate comprising at least two film layers, wherein at least one layer is composed of the cast film as claimed in claim 1.

14. The film laminate of claim 13, wherein the film layers are produced by a coextrusion process.
